(19) United States
(12) Patent Application Publication
(10) Pub. No.: US 2007/0150274 A1
(43) Pub. Date: Jun. 28, 2007

(54) Utterance state detection apparatus and method for detecting utterance state

(75) Inventors: Masakazu Fujimoto, Kanagawa (JP); Yuichi Ueno, Kanagawa (JP); Yasuaki Konishi, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/451,511

(22) Filed: Jun. 13, 2006

(30) Foreign Application Priority Data
Dec. 23, 2005 (JP) 2005-371193

(51) Int. Cl. G10L 15/20

(52) U.S. Cl. 704/233

(57) ABSTRACT

An utterance state detection apparatus includes a transmission device carried by a user and one or more reception devices. The transmission device includes an identification-information storage unit, a speech detector and a transmission unit. The identification-information storage unit stores identification information of at least one of the transmission device and the user. The speech detector detects speech. The transmission unit transmits transmission information including information of the detected speech and the identification information. The reception devices are installed in regions. Each reception device includes an utterance-state detector. If at least one of the reception devices receives the transmission information, the utterance-state detector of the at least one of the reception devices detects an utterance state of the user based on the identification information and the information of the detected speech, which are included in the transmission information received by the at least one of the reception devices.

This application claims priority under 35 U.S.C. 119 from Japanese patent application No.2005-371193 filed on Dec. 23, 2005, the disclosure of which is incorporated by reference herein.

### BACKGROUND

1. Technical Field

The invention relates to a technique for detecting dialogue information indicating that a person is conversing with another person.

2. Related Art

At present, various position detection devices have been provided. Services in which position information of users is measured by means of these devices and the position information is used have been proposed.

An example of the service, which uses the position information, estimates a state based on a place where a user is detected. Specifically, if a user is detected in a conference room, the service estimates that another person is not allowed to cut in, and if it is detected that the user exits the conference room, the service estimates that another person is allowed to cut in.

However, if only information obtained from the position information is used, there is a ceiling to improve accuracy of detecting situation. For example, it is assumed that it is detected that persons A and B are in a conference room during the same period of time. In this case, there are very high possibilities that persons A and B communicate with each other. However, the persons A and B may simply happen to pass each other in a hall way, may be standing and chatting, or may be conversing with someone else. That is, it is unknown whether the persons A and B actually communicate with each other.

### SUMMARY

According to one aspect of the invention, an utterance state detection apparatus includes a transmission device carried by a user and one or more reception devices. The transmission device includes an identification-information storage unit, a speech detector and a transmission unit. The identification-information storage unit stores identification information of at least one of the transmission device and the user. The speech detector detects speech. The transmission unit transmits transmission information including information of the detected speech and the identification information. The reception devices are installed in regions. Each reception device includes an utterance-state detector. If at least one of the reception devices receives the transmission information, the utterance-state detector of the at least one of the reception devices detects an utterance state of the user based on the identification information and the information of the detected speech, which are included in the transmission information received by the at least one of the reception devices.

The invention can be implemented not only by an apparatus or a system, but also by a method. Furthermore, software may also constitute part of the invention. Further, a software product that is used to cause a computer to execute such software is also included within the technical scope of this invention.

The aspect of the invention described above and other aspects will be recited in claims, and will be described in detail by employing the following embodiments.

### BRIEF DESCRIPTION OF THE DRAWINGS

Exemplary embodiments of the invention will be described in detail based on the following figures, wherein:

FIG. 1 is a block diagram showing configuration of an exemplary embodiment of the invention;

FIG. 2 is a flowchart for explaining an example of transmission process performed by a transmission device of the exemplary embodiment;

FIG. 3 is a diagram for explaining an example of data to be transmitted in the exemplary embodiment;

FIG. 4 is a flowchart for explaining an example of reception process performed by a reception device of the exemplary embodiment;

FIG. 5 is a diagram for explaining an example of a utterance state history according to the exemplary embodiment;

FIG. 6 is a flowchart for explaining an example of utterance determination process performed by the reception device of the exemplary embodiment;

FIG. 7 is a flowchart for explaining an example of history analysis process performed by the reception device of the exemplary embodiment;

FIG. 8 is a diagram for explaining an example of history analysis results according to the exemplary embodiment;

FIG. 9 is a flowchart for explaining another example of history analysis process performed by the reception device of the exemplary embodiment;

FIG. 10 is a flowchart for explaining an example of time extraction process performed by the reception device of the exemplary embodiment;

FIG. 11 is a diagram for explaining an example of data structure of a history for each user, according to the exemplary embodiment;

FIG. 12 is a diagram for explaining an example of data structure of a user history for each place, according to the exemplary embodiment;

FIG. 13 is a flowchart for explaining an example of conversation determination process performed by the reception device of the exemplary embodiment;

FIG. 14 is a diagram for explaining an example in which an arrival time and a departure time are obtained, according to the exemplary embodiment;

FIG. 15 is a diagram for explaining an example of a pair of arrival time and departure time for each place, according to the exemplary embodiment;

FIG. 16 is a diagram showing an example of stay period for original data 1 according to the exemplary embodiment;

FIG. 17 is a diagram showing an example of stay period for original data 2 according to the exemplary embodiment;

FIG. 18 is a diagram for explaining an example of dialogue period extraction results according to the exemplary embodiment;

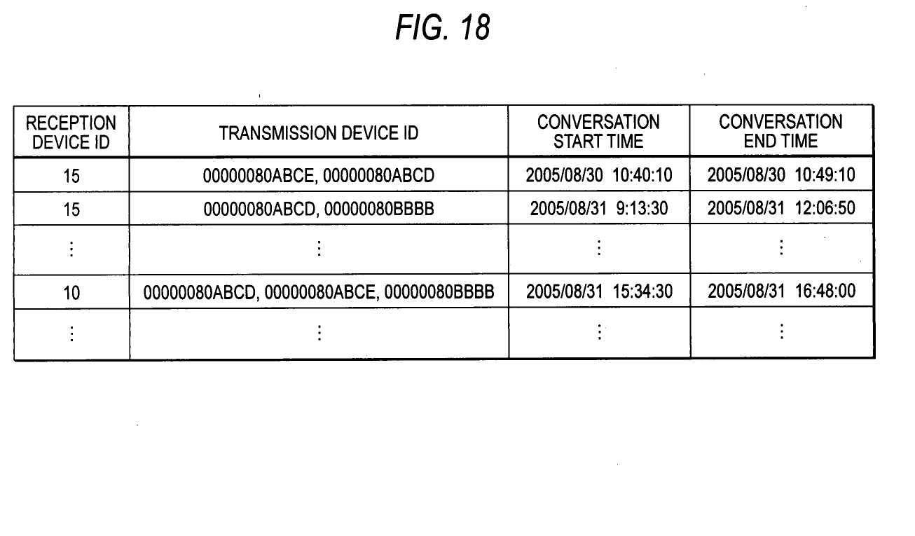

FIG. 19 is a diagram for explaining an installation example in which a communication network is employed, according to the exemplary embodiment; and

FIG. 20 is a diagram showing a modification of the exemplary embodiment.

### DETAILED DESCRIPTION

Exemplary embodiments of the invention will now be described.

### Exemplary Embodiment

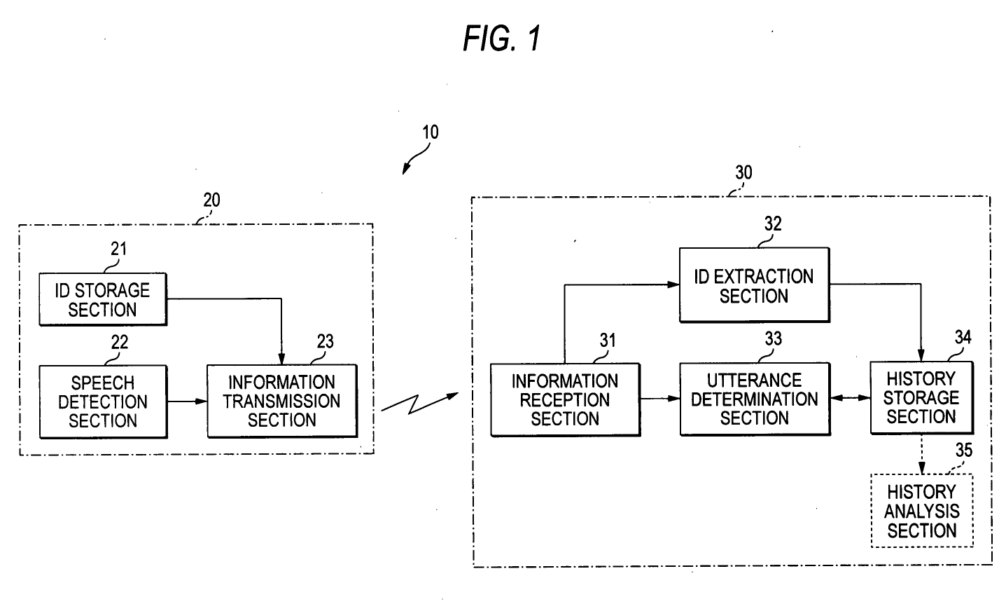

Configuration of an utterance-state detection system 10 according to an exemplary embodiment of the invention is shown in FIG. 1. In FIG. 1, a transmission device 20 is one carried by a user. A reception device 30 is installed in each region (a local area). Only one transmission device 20 and one reception device 30 are shown in FIG. 1. Usually, however, plural transmission devices 10 and plural reception devices 20 are provided. The transmission device 20 is typically an active RFID tag. However, the transmission device 20 is not limited to an RFID tag, and may be a transmission device for an arbitrary position detection system, such as a PHS (Personal Handyphone System), a mobile station for a mobile communication system or an infrared badge (ID tag). The reception device 30 is provided in consonance with the transmission device 20, and receives a transmission signal from the transmission device 20.

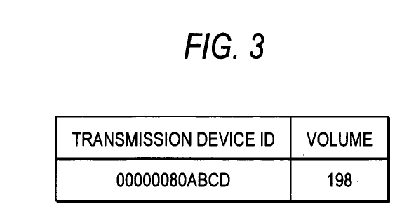

The transmission device 20 includes an ID storage section 21, a speech detection section 22 and an information transmission section 23. The ID storage section 21 stores, as information, an ID unique to each transmission device 20. An ID unique to each user may be registered in the ID storage section 21 instead of the ID of each transmission device 20. Alternatively, the ID storage section 21 may store both of the ID of each transmission device 20 and the ID of each user. The speech detection section 22 is a device, such as a microphone or a bone conductive microphone, for detecting sounds. A frequency filter or a noise canceller may also be built in the speech detection section 22. The information transmission section 23 transmits the ID information and speech level information via a radio wave (when RFID is employed) or an infrared ray (when an infrared badge is employed). An example of transmission data is shown in FIG. 3. The transmission data includes a transmission device ID and volume information.

The reception device 30 includes an information reception section 31, an ID extraction section 32, an utterance determination section 33, a history storage section 34 and a history analysis section 35. The reception device 30 is installed in each region as described above. At the least, the information reception section 31 may be installed in each region, and the other portions of the reception device 30 may be formed as functional portions of a server on a network. In this exemplary embodiment, the information reception section 31, the ID extraction section 32, the utterance determination section 33 and the history storage section 34 are provided at the installation site, and the history analysis section 35 is provided as a functional portion on the server. Of course, the configuration and arrangement of the reception device 30 is not limited thereto.

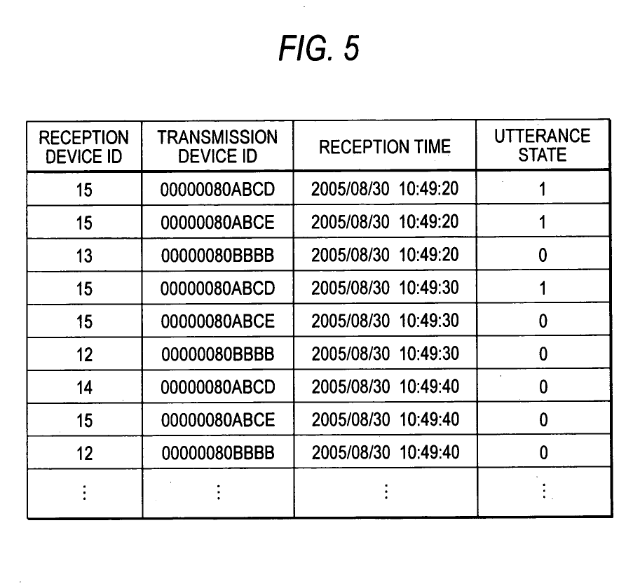

The information reception section 31 receives information from the information transmission section 23 of the transmission device 20, which is located within its detection range at the installation site, and converts the received information into an electric signal. The ID extraction section 32 extracts an ID unique to the transmission device 20 from the received information. The utterance determination section 33 determines whether or not the user is currently speaking, based on speech level information received from the transmission device 20. The history storage section 34 stores, as history data, the ID information unique to the transmission device 20, the position information of the reception device 30 and the utterance determination information. An example of the history data is shown in FIG. 5.

The history analysis section 35 analyzes the recorded history, e.g., extracts a key member who speaks frequently, or calculates an amount of communication performed through dialogues.

A communication section may be provided instead of the history storage section 34, and may transmit the history data to a server. The server may store the history data and calculate an amount of communication.

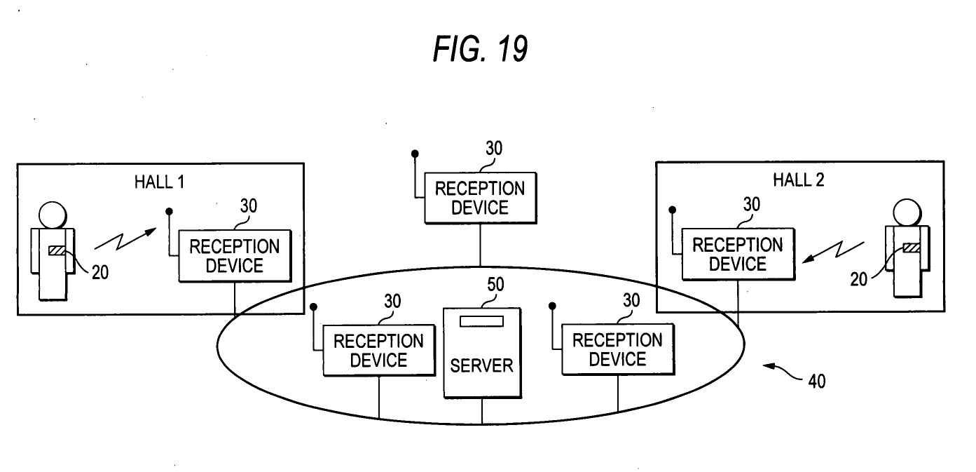

A specific installation example is shown in FIG. 19. FIG. 19 shows an example of a system configuration using a network 40. The reception device 30 is installed in a hall such as a conference room. A targeted user, who is to be detected, carries the transmission device 20. In this system, the history is collected via the network 40, and analyzed by a server 50.

Next, an operation of this exemplary embodiment will now be explained.

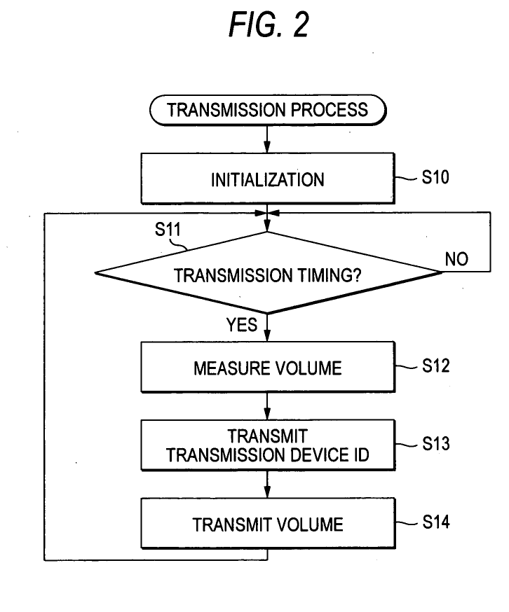

FIG. 2 shows an example of a transmission operation performed by the transmission device. At first, the transmission device 20 performs initialization (S10). Then, the transmission device 20 checks whether or not a transmission timing comes. If not, the transmission device 20 waits for the transmission timing (S11). If the transmission timing comes, the transmission device 20 measures a volume of speech, transmits an ID unique to the transmission device 20 and the volume and then returns to the checking of the transmission timing (S12 to S14). As described above, data to be transmitted is one shown in FIG. 3. Typically, the data to be transmitted includes a transmission device ID and volume information.

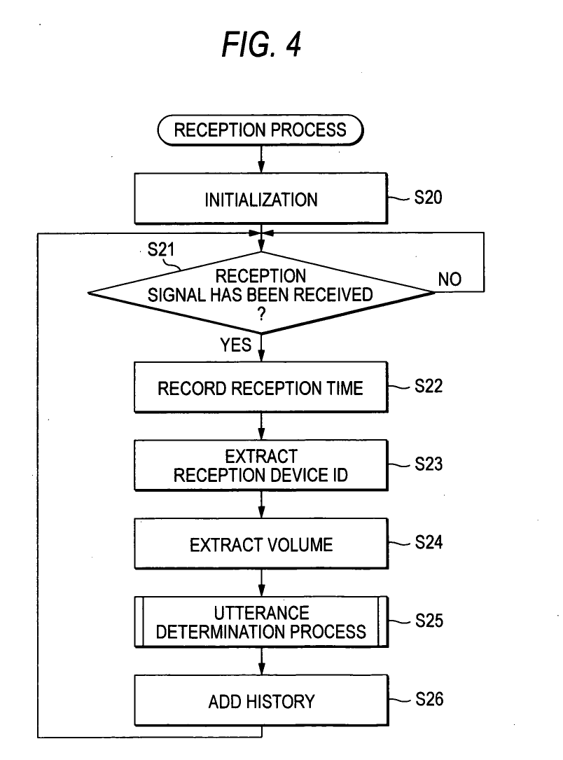

FIG. 4 shows an example of a reception operation performed by the reception device 30. At first, the reception device 30 performs initialization (S20). Then, the reception device 20 checks whether or not a reception signal has arrived. If not, the reception device 30 waits for the arrival of the reception signal (S21). When the reception signal has arrived, the reception device 30 records the reception time, extracts the ID unique to the transmission device 20 from the reception signal, and further extracts the volume information (S22 to S24). The reception device 30 determines an utterance state based on the extracted volume information (S25). Thereafter, the reception device 30 stores the utterance state history data (S26), returns to step S21, and repeats the processing. For example, the utterance state history data includes, as shown in FIG. 5, a reception device ID, a transmission device ID, a reception time and an utterance state flag (“1” indicates a state where a user is speaking).

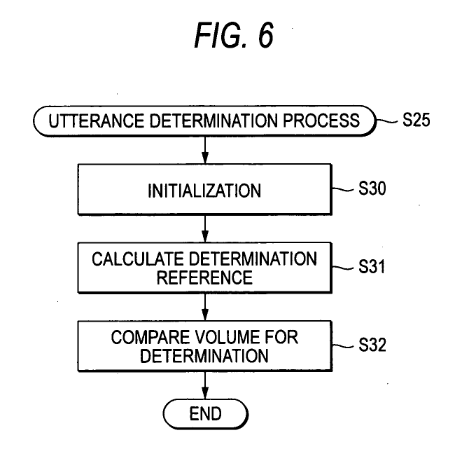

FIG. 6 shows an example of the utterance determination processing (S25). At first, the utterance determination section 33 performs initialization (S30), and then calculates a determination reference value is calculated (S31). The determination reference value may be a fixed value, which is set up in advance. Alternatively, the utterance determination section 33 may calculate an average of past volume data and set the average to the determination reference value. In this case, it is necessary for the utterance determination section 33 to store data such as the average value and number of pieces of the reception data. If the utterance determination section 33 stores the average value and number of pieces of the reception data, the utterance determination section 33 can update by using the following expression.

$$\begin{matrix}( average value ) = ( previous average value ) + \\ \frac{( volume ) - ( previous average value )}{( number of data ) + 1}\end{matrix}$$

Then, the utterance determination section 33 determines whether or not utterance occurs based on the current volume, and outputs the results (S32). For example, the utterance determination section 33 may compare the current volume with a determination reference value to determine whether or not the utterance occurs.

It is noted that in some cases, it may be difficult to make the determination based on a fixed reference value because a place to be determined is noisy or because persons taking part in the conversation are excited. Therefore, in order to take a countermeasure against such noisy situations, the utterance determination section 33 may employ a noise canceller technique, may use position information to select one of different determination reference values in accordance with places, or may use member information to select one of the different determination reference values.

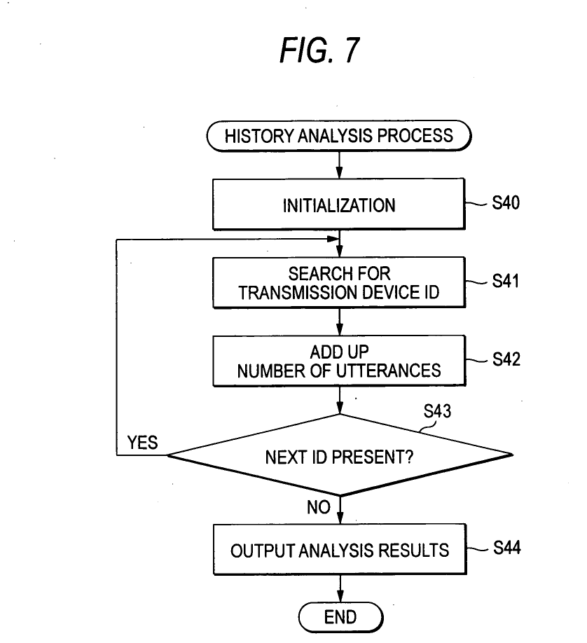

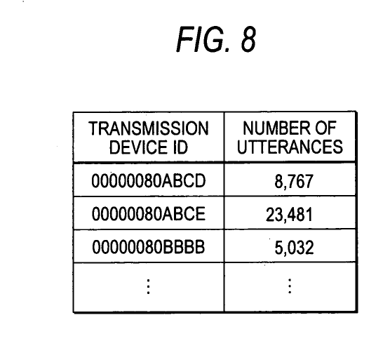

FIG. 7 shows an example of an analysis operation performed by the history analysis section 35. In FIG. 7, as a simple example of the history analysis process, calculating an amount of speech uttered for each transmission device ID will be described. First, when the history analysis section 35 starts the history analysis process, the history analysis section 35 performs initialization (S40). Then, the history analysis section 35 searches for a history of a transmission device ID, which is a calculation target (S41). Subsequently, the history analysis section 35 adds up number of times the utterance state is ON in the found history data (S42). If a next transmission device ID remains, the history analysis section 35 returns to the transmission device ID search process (S43). If no transmission device ID remains, the history analysis section 35 outputs the calculation results and terminates the history analysis process (S44). The history analysis results (the calculation results) are, for example, as shown in FIG. 8.

Here, an amount of the speech uttered in all data is calculated. However, the history analysis process may be performed with respect to only one conference. Alternatively, the history analysis process may be performed with respect to all meetings of a particular group.

Further, the adding-up period may be limited to a predetermined period (e.g., one month), and time change may be checked.

Next, another history analysis process will now be explained. Here, as another history analysis process, a conversation state between users who carry the transmission devices 20 is detected.

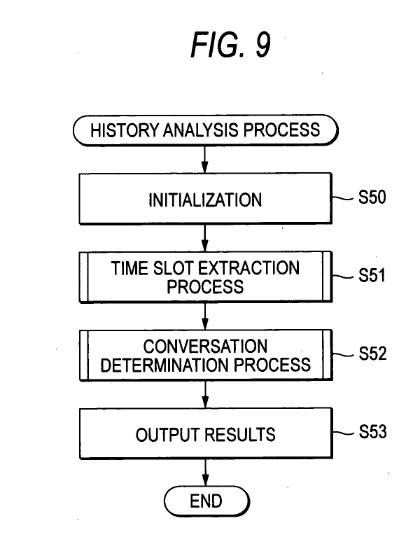

FIG. 9 shows an example of this history analysis process. At first, the history analysis section 35 performs initialization (S50) and then, performs a process of extracting a time slot during which a user is at a predetermined place (S51). Following this, the time slot data are employed to provide a data group indicating the users are currently engaged in communication, and the results are output (S52 and S53).

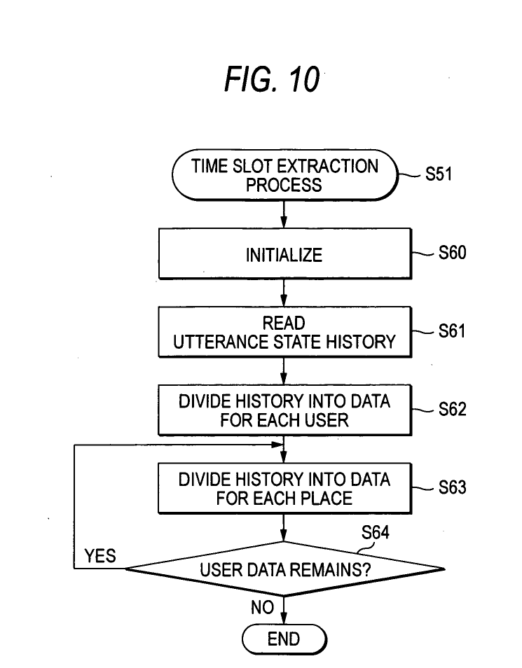

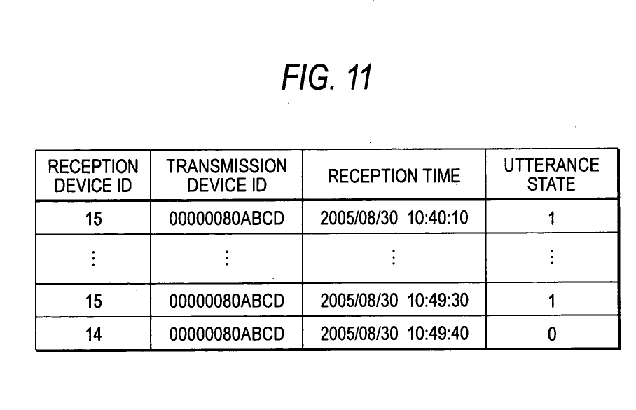

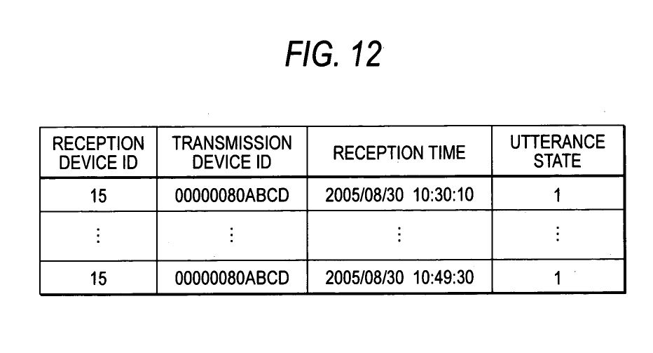

FIG. 10 shows an example of the time slot extraction process (S51). At first, the history analysis section 35 performs initialization (S60) and then reads the utterance state history. Then, the history analysis section 35 divides the utterance state history into histories for respective users (transmission devices 20) (S62). FIG. 11 shows an example of thus obtained data for respective users. Subsequently, the history analysis section 35 divides the history for each user into histories for respective places where the user is detected continuously (S63). An example wherein data for a specific user is divided into histories for respective places is shown in FIG. 12. The history analysis section 35 can determines whether or not plural users are at the same place, by using the data shown in FIG. 12. The data shown in FIG. 12 corresponds to a series of actions that one user keep staying at a particular place continuously, may be used in subsequent process as original data and is assigned to original data numbers (although not shown). It is not necessary that only a single reception device is provided in a place to be distinguished. That is, plural reception devices may be provided in the same place. In that case, data of all reception device IDs may be handled collectively. If another user data to be divided remains, the history analysis section 35 returns to the process of dividing (S63). If the history analysis section 35 has performed the process of dividing for all the users, the history analysis section 35 terminates the time-slot extraction process (S64).

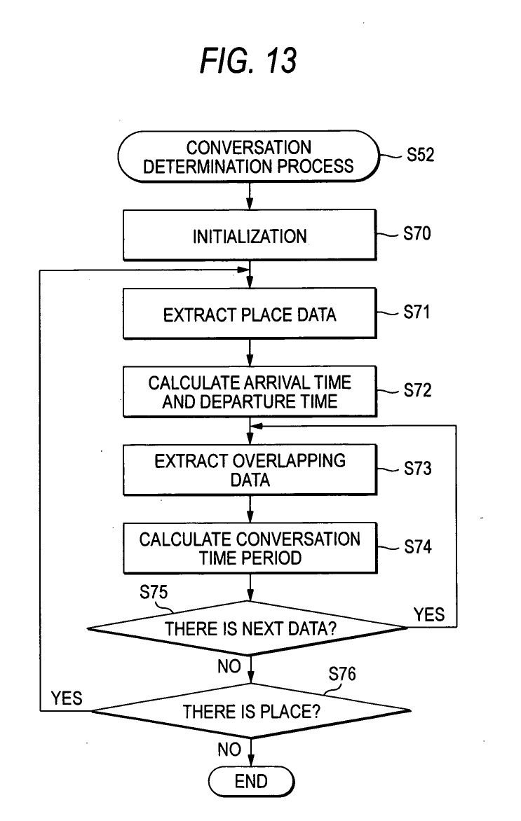

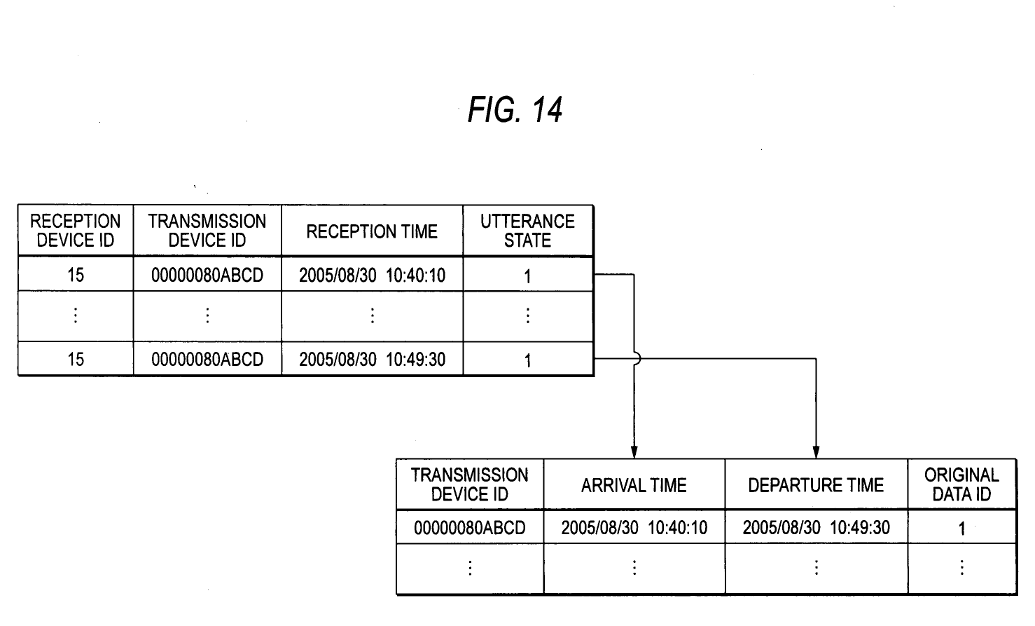

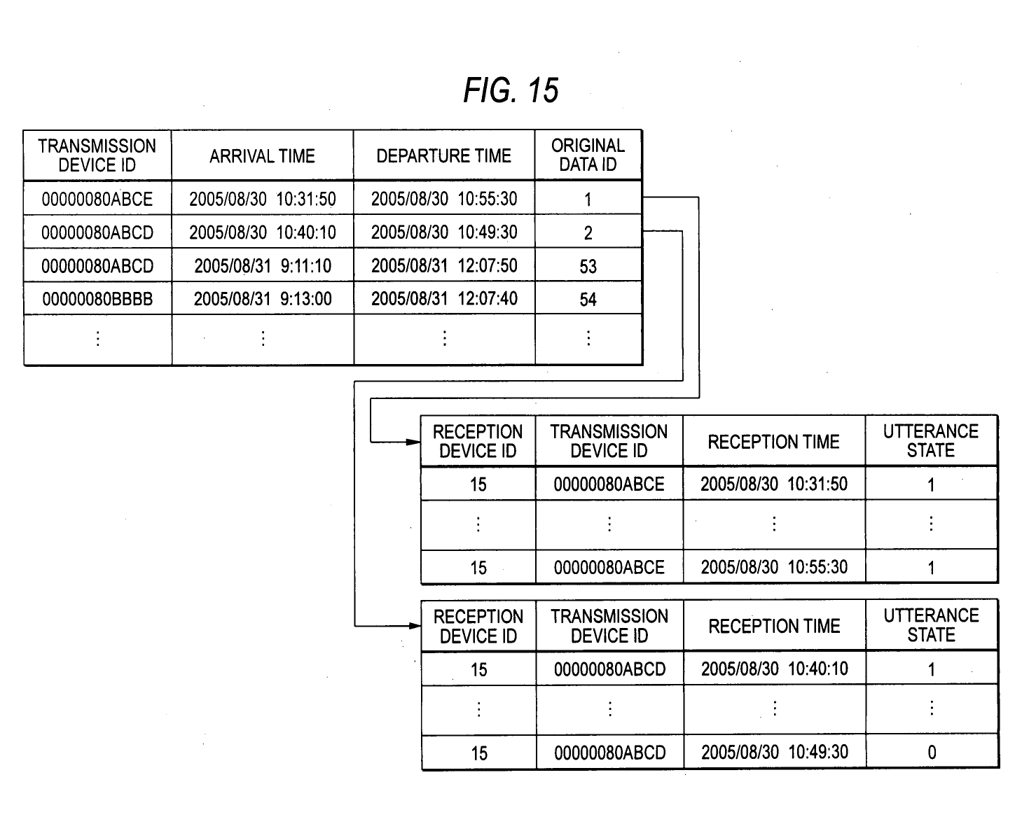

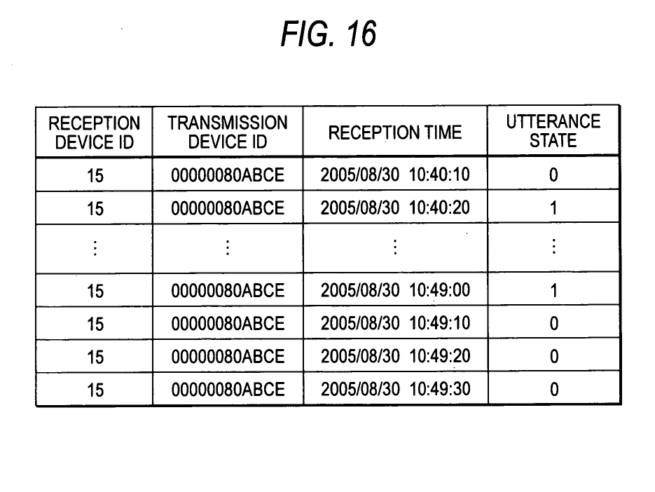

FIG. 13 shows an example of the conversation determination process (S52). At first, the history analysis section 35 performs initialization (S70) and extracts a user history for each place on a place basis (S71). Sequentially, the history analysis section 35 calculates arrival time and departure time as shown in FIG. 14 based on the user history for each place (see FIG. 12), and rearranges obtained data including a transmission device ID, arrival time, departure time and original data ID (original data number) in order of the arrival time (S72). Next, as shown in FIGS. 15 to 17, the history analysis section 35 obtains data in which arrival time and departure time overlap (S73). The history analysis section 35 refers to an utterance state in data in which arrival time and departure time overlap, and calculates start time of the utterance and end time of the utterance (S74). When the history analysis section 35 examines the utterance states for all the overlapping data, the history analysis section 35 returns to the process performed for the history of the next place (S75 and S76). When the history analysis section 35 has made determination regarding all the places, the history analysis section 35 terminates the processing (S76).

A specific example of the above processing will be further described. It is assumed that plural pieces of data are arranged in order of the arrival time, that two transmission devices are referred to as A and B, that Ta(A) and Ta(B) represent that arrival times of the transmission devices and that T1 (A) and T1 (b) represent departure time of the transmission devices. The history analysis section 35 can extract data in which arrival time and departure time overlaps by searching for data satisfying:

Ta(A)≦Ta(B)<T1(A)

Further, simultaneous detection time (conversation time period) is from max(Ta(A), Ta(B)) to min(T1(A), T1(B)). In the case where three or more persons, the same method can be applied.

In the example shown in FIG. 15, the following facts can be seen. Two transmission devices having transmission device IDs 00000080ABCD and 00000080ABCE were detected in the same place from 10:40:10 to 10:49:30 on Aug. 30, 2005. Similarly, two transmission devices having transmission device IDs 00000080ABCD and 00000080BBBB were detected in the same place from 9:13:00 to 12:07:40 on Aug. 31, 2005.

When it is found that plural transmission devices were detected in the same place, the history analysis section 35 determines whether or not actual conversations were made, form the utterance state of the original data and then, obtains the conversation time period.

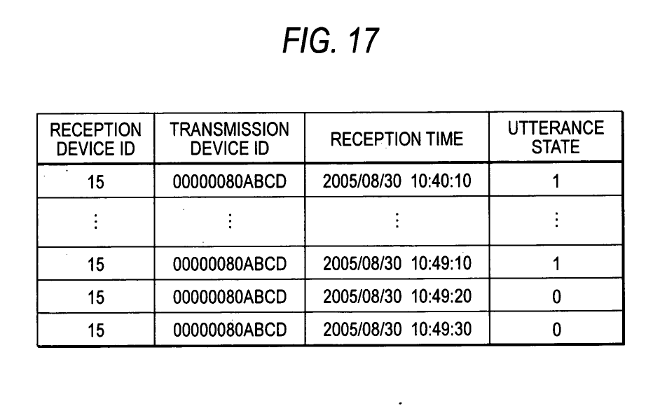

Here, described is an example where the history analysis section 35 calculates the conversation time period from 10:40:10 to 10:49:30 on Aug. 30, 2005 in which the transmission device IDs 00000080ABCD and 00000080ABCE were detected at the same time. At first, the history analysis section 35 extracts only the overlapping portion of the original data, and sets the earliest time at which the utterance state was detected (in this example, 10:40:10 on Aug. 30, 2005 for original data ID=2; see FIG. 17) as a conversation start time. Also, the history extraction section 35 sets time at which the established utterance state was detected (in the example, 10:49:10 on Aug. 30, 2005 for original data ID=2; see FIG. 17) as the conversation end time. Therefore, the history analysis section 35 determines that the period of conversation between the transmission device IDs 00000080ABCD and 00000080ABCE is from 10:40:10 to 10:49:10 on Aug. 30, 2005.

The exemplary embodiment of this invention has been explained.

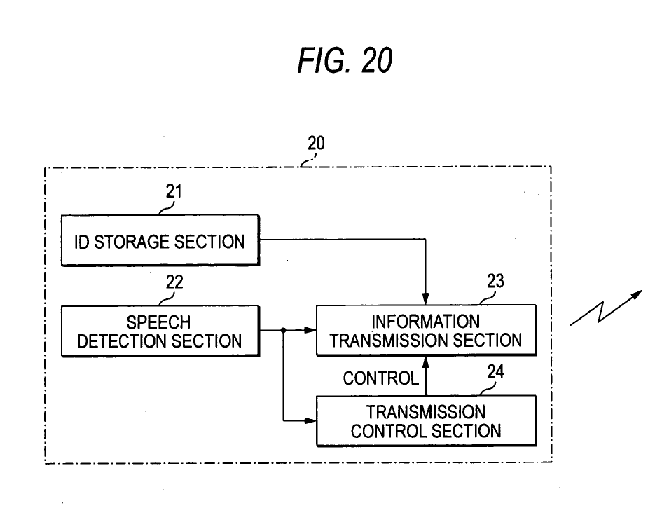

The invention, however, is not limited to the exemplary embodiment, and can be variously modified without departing from the gist of the invention. For example, utterance state information or conversation state information in the embodiment may be substantially obtained in real time, and a predetermined service may be provided or prohibited by using such information. For example, either the reception of calls by a mobile phone may be inhibited when a user is speaking or is engaged in a conversation, or introduction information may be provided when the user is not speaking or is not actively communicating. Further, although in the above embodiment information is periodically transmitted, a vibration detection device may be provided that inhibits transmissions while a user is moving. Furthermore, while as shown in FIG. 20 transmissions may be performed even when an utterance state has been detected, a transmission control section 24, for example, may inhibit transmissions when a volume level is lower than a specified utterance level, which is a threshold level (minimum signal level) used to determine the utterance state. Of course, since breaks in speech often occur, it is preferable that a specified integration process be performed to ensure that, in an utterance state, short, voiceless periods are ignored. Also, switching may be employed either to enable the transmission of calls when speech is substantially at a predetermined level or to enable the transmission of calls regardless of the speech level attained. When, in this case, transmission is enabled substantially at a predetermined speech level, location information for a person can be analyzed while focusing on an utterance or on a dialogue. Further, a mode can be changed in accordance with the preferences of a user. In addition, the individual sections of the transmission device in FIG. 20 may either be integrally mounted on a transmission device, such as an RFID tag, or a configuration may be employed wherein a speech detector is connected to the main body of the transmission device using a connector.

What is claimed is:

1. An utterance state detection apparatus comprising:
a transmission device carried by a user, the transmission device comprising:
an identification-information storage unit that stores identification information of at least one of the transmission device and the user;
a speech detector that detects speech; and
a transmission unit that transmits transmission information comprising information of the detected speech and the identification information; and
one or more reception devices installed in one or more regions, each reception device comprising an utterance-state detector, if at least one of the reception devices receives the transmission information, the utterance-state detector of the at least one of the reception devices detecting an utterance state of the user based on the identification information and the information of the detected speech, which are included in the transmission information received by the at least one of the reception devices.

2. The apparatus according to claim 1, wherein the transmission device is a plurality of transmission devices, the apparatus further comprising:
a determination unit that determines a conversation state among a plurality of users of the transmission devices, on a basis of the utterance states detected by the utterance state detector of the at least one of the reception devices.

3. The apparatus according to claim 1, wherein the transmission unit comprises one selected from a group consisting of an RFID tag, a PHS and an infrared badge.

4. The apparatus according to claim 1, wherein:
the speech detector comprises a microphone that receives the speech, and
the speech detector detects volume of the speech received by the microphone.

5. The apparatus according to claim 1, wherein:
the speech detector comprises a bone conduction microphone that receives the speech transmitted via bones of the user, and
the speech detector detects volume of the speech received by the bone conductive microphone.

6. The apparatus according to claim 1, wherein the speech detector detects whether or not volume of the detected speech exceeds an utterance level to determine whether or not utterance occurs.

7. The apparatus according to claim 1, wherein the utterance-state detector determines on a basis of the information of the speech included in the transmission information, whether or not the detected speech exceeds an utterance level to determine whether or not utterance occurs.

8. An identification information detection apparatus comprising:
a transmission device carried by a user, the transmission device comprising:
an identification-information storage unit that stores identification information of at least one of the transmission device and the user;
a speech detector that detects speech; and
a transmission unit that transmits transmission information comprising the identification information, on a basis of the detected speech; and
one or more reception devices installed in one or more regions, each reception device that receives the transmission information and obtains the identification information included in the received transmission information.

9. The apparatus according to claim 8, wherein the transmission unit enables a transmission function on a basis of the detected speech.

10. A transmission device comprising:
an identification-information storage unit that stores identification information of at least one of the transmission device and a user;
a speech detector that detects speech; and
a transmission unit that transmits transmission information comprising the identification information, on a basis of the detected speech.

11. A method for detecting an utterance state, the method comprising:
detecting speech;
transmitting transmission information comprising information of the detected speech and identification information of at least one of a transmission device and a user;
receiving the transmitted transmission information; and
detecting a conversation state of the user of the transmission device on a basis of the identification information and the information of the detected speech, which are included in the received transmission information.

12. A transmission device comprising:
an identification-information storage unit that stores identification information of at least one of the transmission device and a user;
a speech detector that detects speech; and
a transmission unit that transmits transmission information comprising the identification information and information of the speech detected by the speech detector, the transmission unit transmitting the transmission information to one or more reception device provided in a facility as a fixed station.
